(19) United States
(12) Patent Application Publication
(10) Pub. No.: US 2019/0288491 A1
(43) Pub. Date: Sep. 19, 2019

(54) Electric Circuit Wire Reference Tool

(71) Applicants: Eric Lewis, Pasadena, CA (US); Thomas Saunders, Glendora, CA (US)

(72) Inventors: Eric Lewis, Pasadena, CA (US); Thomas Saunders, Glendora, CA (US)

(21) Appl. No.: 15/919,358

(22) Filed: Mar. 13, 2018

(51) Int. Cl. H02G 1/00; H01B 7/36; G09F 3/20

(52) U.S. Cl. CPC H02G 1/00; H02G 2200/20; G09F 3/208; H01B 7/36

(57) ABSTRACT

This invention is a hand tool with a body, electric circuit wiring reference information on the front and back, a protective shell, and support magnets.

### BACKGROUND

The present disclosure is generally directed to identification systems for electrical wiring, and more particularly to a hand tool to allow identification of electrical wires that have been labeled according to a specific labeling scheme.

Electricians and other tradesmen working with electric circuit wiring require a standard way to identify and label circuits and wires in order to allow others to work with the circuits without undue testing or experimenting to discover the layout of the circuit wires, and without fear for their safety if handling an incorrectly identified wire, can lead to electrical shock and/or fires. Labeling and color-coding schemes exist, such as that described in U.S. Pat. No. 5,862,774 (an electrical wire marking method and system for identifying a wire with a particular circuit). In order to follow such a scheme while installing electric circuit wiring or working with already installed electric circuit wiring, however, electricians and tradesmen must rely on their memory or memory-aiding devices. Such devices currently include commercial products such as the “LifeBolt Silicone Code Band with Electrical Wiring Color Codes reference”, or certain smartphone applications. Such products, however, suffer from the drawbacks of providing incomplete information (such as the bracelet only providing circuit references for 120 or 208 volts), being unreliable (such as when a smartphone runs out of battery), or being inconvenient to use while working (such as having to hold a smartphone in one hand or attempt to prop the device up in a visible location).

It would be useful to have a reliable, convenient, complete, easy-to-use method or device for identifying electric wiring.

### SUMMARY

In one example of an electric circuit wire reference tool according to this invention, the tool has a body, front and back information references, a protective shell, and support magnets.

These as well as other aspects, advantages, and alternatives, will become apparent to those of ordinary skill in the art by reading the following detailed description, with reference where appropriate to the accompanying drawings.

### BRIEF DESCRIPTION OF THE DRAWINGS

FIG. 1 is an isometric view of an example embodiment.

FIG. 2 is a front view of an example embodiment.

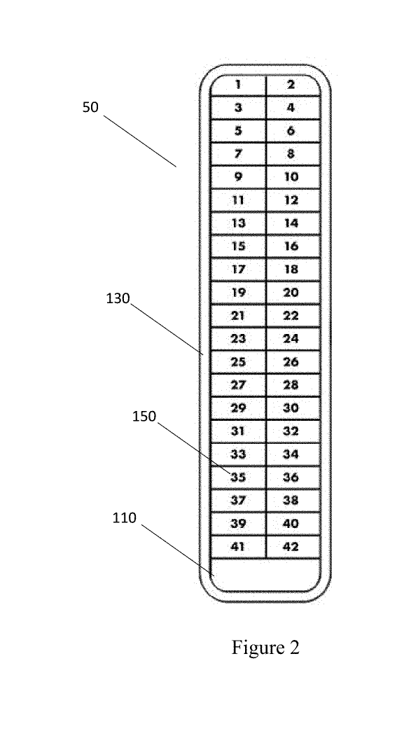

FIG. 3 is a side view of an example embodiment.

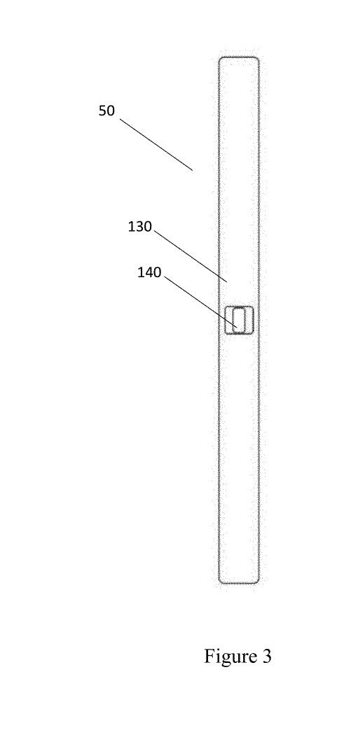

### DETAILED DESCRIPTION

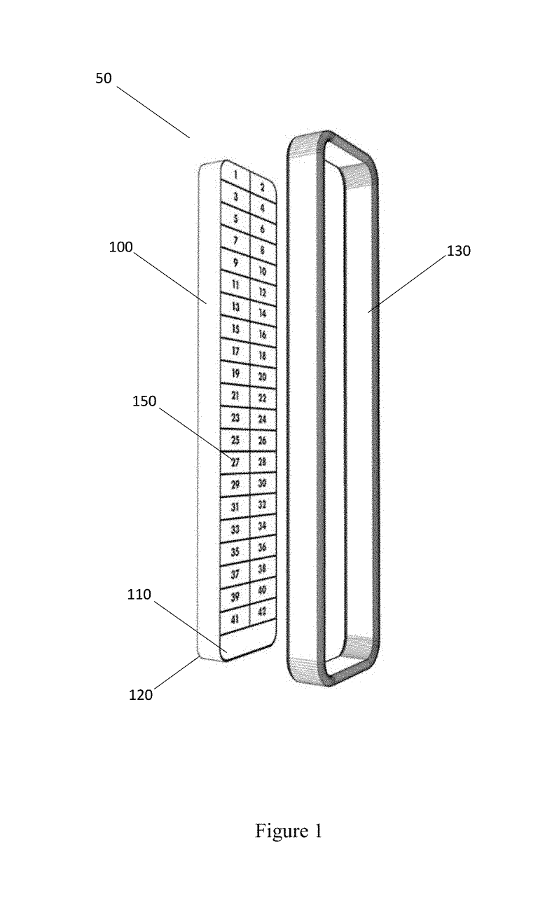

In the particular embodiment illustrated in FIG. 1, the tool 50 includes a body 100, a front side 110, a rear side 120, protective shell 130, support magnets 140, and reference information 150. The body 100 has a rectangular or polygon shape. The body 100 is composed of any suitable, non-conductive material, such as molded plastic or hard rubber, and is fabricated using any suitable process. The material should be light-weight, allow for gripping by a human hand without slipping, and allow for reference material to be printed and easily viewed. The body 100 is substantially rigid, durable enough to provide a protective cover for the internal components, and thin and light enough that support magnets 140 will support the entire device, when coupled to a magnetic surface. Body 100 has a basic rectangular shape, and is shaped and sized such that, when combined with other components of tool 50, the entire device can be easily held in one hand by a typical adult, and the device can be placed and stored in a tool belt, pouch, or box.

Front side 110 is a flat surface that has reference information 150 printed on it. Reference information 150 is printed in two or more columns, with each column or set of columns corresponding to wiring information for a particular voltage number or set of voltage numbers, such as 120/208 or 277/480. Each entry in a column contains a number corresponding to a circuit number (typically 1-42). Each entry in a column is also color-coded to indicate what color the corresponding wire in the actual electric circuit should be (black, red, or blue for 120/208 voltage; brown, orange, or yellow for 277/480 voltage). Reference information 150 is printed in characters that are easily visible at a distance of 2-3 feet. Reference information 150 is also printed in a manner such that the characters and coloring do not easily degrade under typical usage conditions (e.g. rubbing against other tools, getting wet). Reference information 150 may also be printed on a separate surface that is designed to be laid atop front side 110 and secured by protective shell 130.

Rear side 120 is a flat surface that also has reference information 150 printed on it. The reference information 150 printed on rear side 120 should be the wiring information for voltage numbers that are not included on front side 110 (e.g. if front side 110 contains wiring information for voltage 120/208, then rear side 120 should contain information for voltage 277/480). Rear side 120 is not illustrated in detail because it is substantially similar to front side 110.

Protective shell 130 is a band that is designed to be affixed around body 100. Protective shell 130 is composed of a substantially rigid yet slightly flexible material, such as rubber. Protective shell 130 may optionally be removable by a user, or may be permanently affixed to body 100 by means of glue, screws, rivets, or other appropriate securing mechanisms.

Support magnets 140 are rare-earth magnets that can be either built into body 100 or inserted beneath protective shell 130 and secured in place by protective shell 130. Support magnets 140 can be any size or shape that allows them to fit within tool 50. Support magnets 140 should be powerful enough to adhere to metal surfaces commonly found on or near electric circuit wiring and support the entire tool 50. Support magnets 140 allow the tool 50 to be securely attachable to electrical panels and other metals/conduits/surfaces related to commercial electrical wiring, making the device more convenient to use.

While various aspects and embodiments have been disclosed herein, other aspects and embodiments will be apparent to those skilled in the art. The various aspects and embodiments disclosed herein are for purposes of illustration and are not intended to be limiting, with the true scope and spirit being indicated by the following claims. Other embodiments may be utilized, and other changes may be made, without departing from the spirit or scope of the subject matter presented herein, for example, body 100 may be constructed without support magnets 140. It will be readily understood that the aspects of the present disclosure, as generally described herein and illustrated in the figures, can be arranged, substituted, combined, separated, and designed in a wide variety of different configurations, all of which are contemplated herein.

What is claimed is:

1. A hand tool comprising:
a tool body having a first surface, a second surface, and a third surface, where the second surface is parallel to the first surface and is on the opposite side of the tool body;
electric circuit reference material printed on the first surface of the tool body;
electric circuit reference material printed on the second surface of the tool body;
a protective shell enclosing the third surface of the tool body;
a magnet attached to the third surface of the tool body.

2. The hand tool of claim 1, wherein the tool body has a substantially rectangular shape.

3. The hand tool of claim 1, wherein the electric circuit reference material is color-coded.

4. The hand tool of claim 2, wherein the electric circuit reference material is color-coded.
